(19) United States
(12) Patent Application Publication
(10) Pub. No.: US 2025/0026329 A1
(43) Pub. Date: Jan. 23, 2025

(54) BRAKE SYSTEM FOR A MOTOR VEHICLE

(71) Applicant: ZF CV Systems Global GmbH, Bern (CH)

(72) Inventors: Mirko Brütt, Springe (DE); Michael Haverkamp, Hannover (DE)

(73) Assignee: ZF CV Systems Global GmbH, Bern (CH)

(21) Appl. No.: 18/777,687

(22) Filed: Jul. 19, 2024

(30) Foreign Application Priority Data
Jul. 21, 2023 (DE) 10 2023 206 957.1

(51) Int. Cl. B60T 13/66; B60T 17/16

(52) U.S. Cl. CPC B60T 13/662; B60T 17/16; B60T 2270/402; B60T 2270/413

(57) ABSTRACT

A brake system for a motor vehicle includes a control valve, a redundancy valve, a brake valve, a brake cylinder, a pressure fluid source, an electronic control unit, a parking lock, and a depressurized tank. The control valve and the redundancy valve are mechanically preloaded in a closed state, whereas the brake valve is mechanically preloaded in an open state. The electronic control unit is configured to control the brake valve so that it moves into a closed state so that pressure fluid flows out of the brake cylinder via the brake valve directly into the depressurized tank, and no pressure fluid is fed into the brake cylinder via the control valve or the redundancy valve and the brake valve, if the control valve or the redundancy valve remains in an open state due to a mechanical defect and otherwise should be in the closed state.

### RELATED APPLICATIONS

This application claims the benefit of and right of priority under 35 U.S.C. § 119 to German Patent Application no. 10 2023 206 957.1, filed on 21 Jul. 2023, the contents of which are incorporated herein by reference in its entirety.

### FIELD OF THE DISCLOSURE

The invention relates to a brake system for a motor vehicle.

### BACKGROUND

DE 10 2020 121 082 A1 discloses an electronically controllable, pressurized secondary brake system for a commercial vehicle. The secondary brake system comprises spring-applied brake cylinders and an electronically controllable brake control valve, by means of which the braking force of the spring-applied brake cylinders can be reduced by a pressure fluid supply and increased by a pressure fluid discharge. Furthermore, the secondary brake system comprises an electronic brake control unit for controlling the brake control valve depending on a current value of a brake value signal. A pressure fluid inlet of the brake control valve is connected to a pressure fluid source via a supply line, a pressure fluid outlet of the brake control valve is connected to a pressure fluid sink and a working connection of the brake control valve is connected to the spring brake cylinders via a working line. In addition, a 3/2-way solenoid switching valve and a non-return valve blocking in the direction of the brake control valve are arranged in the working line.

Furthermore, according to DE 10 2020 121 082 A1, a control input of the non-return valve can be connected alternately to the pressure fluid source or a depressurized hydraulic reservoir via the 3/2-way solenoid switching valve, so that the non-return valve is open/closed in the direction of the brake control valve when the 3/2-way solenoid switching valve is energized/de-energized. A hand pump is connected to the working line via a pressure line. In the event of a fault in the 3/2-way solenoid switching valve, this can be used to manually feed hydraulic oil from a depressurized hydraulic reservoir into the spring brake cylinders. No redundancy is provided for the 3/2-way solenoid switching valve, so that if it is opened unintentionally, the spring brake cylinders are vented via the non-return valve and the brake control valve. EP 3 536 570 B1, on the other hand, has redundancy in the form of a control valve and a redundancy valve for a parking brake module. This increases safety in the event of electrical failures, but still requires a mechanical interface in the cab to release the pressure from the spring brake cylinders.

To create redundancy, solutions with bistable valves and redundant control units are also known. Bistable valves typically remain in one position in the event of an electrical or mechanical failure. This means that no emergency function is possible if the parking lock is activated incorrectly. If the parking brake is deactivated by mistake, the driver still needs a mechanical interface to release the pressure manually with this solution. Redundant control units require additional costs for a second control unit and software development. This solution only makes sense if two control units are already used in the vehicle.

### SUMMARY

One task of the present invention can be seen in providing a brake system with reduced hardware and software complexity. The brake system is designed to ensure that a parking lock can be activated in the event of an unintentionally jammed valve. The object is achieved by a brake system as disclosed herein. Further advantageous embodiments and variations will be apparent from the following description and the figures.

The present invention provides a brake system for a motor vehicle. The brake system comprises a first directional control valve designed as a control valve, a second directional control valve designed as a redundancy valve and a third directional control valve designed as a brake valve. The brake system also comprises a brake cylinder. The invention is described below primarily in connection with a brake cylinder. However, these explanations also apply mutatis mutandis to several such brake cylinders, which can in particular be connected in parallel to the brake valve. The brake cylinder or its piston rod is connected to a parking lock, in particular mechanically. In alternative embodiments, the brake system does not have a second directional control valve designed as a redundancy valve.

The brake system also comprises a pressure fluid source. The pressure fluid source (e.g., a tank or accumulator) is set up to dispense a pressure fluid. When the ignition of the motor vehicle is switched on, a drive motor of the motor vehicle can cause the pressure fluid source to be filled. The pressure fluid can be a pneumatic pressure fluid (e.g., compressed air) or a hydraulic pressure fluid (e.g., oil). The brake system can therefore also be a pneumatic or hydraulic brake system. The brake system also comprises an electronic control unit, a parking lock, and a depressurized tank. The parking lock is designed to lock at least one wheel of the motor vehicle if and as long as the parking lock is activated. In particular, a mechanical parking lock can lock the at least one wheel of the motor vehicle, wherein the mechanical parking lock is preloaded by a parking lock spring in such a way that the parking lock is activated. The piston slide of the brake cylinder can release the preload of the parking lock spring so that the parking lock function is deactivated. To do this, a deactivation pressure must be built up within the brake cylinder.

If the parking lock is to be released during normal operation, especially if the electronic control unit is in an active state, then both the control valve and the redundancy valve are activated so that they are in an open state. The control valve and the redundancy valve then supply the brake valve with pressure or pressure fluid. In particular, the brake valve is a normally open proportional valve (pressure reduction on activation), especially a 3/3-way directional control valve. The brake valve is not activated, i.e., it transmits the pressure to the brake cylinder when it is in the open state. The pressure status can be monitored via a pressure sensor. The pressure builds up inside the brake cylinder until a spring-applied brake in particular is fully released. The control valve and the redundancy valve remain permanently active as long as the parking lock is released, i.e., while the vehicle is moving. In this sense, in the brake system according to the invention, it is provided that the control valve and the redundancy valve are mechanically preloaded in a closed state, whereas the brake valve is mechanically preloaded in an open state. The electronic control unit is set up to control the control valve and the redundancy valve in such a way that they move into an open state against the mechanical preload. As a result, pressure fluid is fed from the pressure fluid source via the control valve and the redundancy valve and downstream via the brake valve, which is mechanically preloaded in the open state, into the brake cylinder. The pressure fluid builds up a deactivation pressure in the brake cylinder so that the parking lock is deactivated.

In the event of a mechanical defect on the control valve or on the redundancy valve, which leads to a jammed opening position of the relevant valve, the pressure on the brake cylinder cannot be released via the jammed valve when the parking brake is applied. As long as the ignition is switched on or the electronic control unit for controlling the individual devices is energized, this pressure in the brake cylinder can be relieved by opening the brake valve, overcoming the constant supply from the defective valve. In this sense, the electronic control unit of the brake system according to the invention is set up to control the brake valve in such a way that it moves into a closed state, so that pressure fluid flows out of the brake cylinder via the brake valve directly into the depressurized tank and no pressure fluid is fed into the brake cylinder via the control valve or via the redundancy valve and the brake valve if the control valve or the redundancy valve remains in the open state due to a mechanical defect, although it should be in the closed state.

If the electronic control unit is now to be switched off, the brake valve would also be switched off, which would pressurize the brake cylinder again and release the parking brake. To avoid such a risky situation, a mechanism is provided, implemented in particular by software, which alternately opens and closes the brake valve. When the ignition of the motor vehicle is switched off, so that the engine for driving the motor vehicle is no longer running, the chamber of the brake cylinder is alternately filled, pressurized, and vented again, so that the pressure fluid source (tank or accumulator), which feeds the parking brake system, is emptied until a defined limit pressure, e.g., the deactivation pressure, is no longer reached within the brake cylinder. In this sense, according to one embodiment, the electronic control unit is designed to control the brake valve in such a way that it alternately moves into the open and closed state when an ignition of the motor vehicle is switched off. As a result, the brake cylinder is alternately filled and emptied until the pressure fluid source is emptied in such a way that the pressure inside the brake cylinder no longer reaches a specified limit pressure during filling. In particular, the electronic control unit is set up to switch off if the pressure inside the brake cylinder no longer reaches the limit pressure during filling.

While the brake cylinder is pressurized, a sufficiently low pressure level of the accumulator can be detected via a pressure sensor. If a certain threshold value is reached that allows the vehicle to come to a safe standstill, the electronic control unit can be switched off. In this sense, according to a further embodiment, the brake system further comprises a pressure sensor adapted to measure a line pressure within a line connecting the brake valve to the brake cylinder, wherein the processor unit is adapted to access the line pressure measured by the pressure sensor and to shut down when the line pressure no longer reaches the predetermined limit during filling of the brake cylinder.

According to a further embodiment, it is provided that the brake system further comprises an electronic locking unit, wherein the control valve moves into the closed state by the mechanical preload when the electronic control unit is in an inactive state, so that no pressure fluid is conducted from the pressure fluid source via the control valve in the direction of the brake valve. Accordingly, no pressure fluid is fed into the brake cylinder via the control valve and the brake valve in order to build up the deactivation pressure so that the parking lock is deactivated.

The characteristic “inactive state” can be understood in particular to mean that the electronic control unit can no longer control the control valve, the redundancy valve, and the brake valve. In particular, energization of the solenoids of the control valve, redundancy valve, and brake valve is no longer controlled by the electronic control unit when the electronic control unit is in the inactive state. The electronic control unit is in an inactive state, especially if it fails when a fault occurs. On the other hand, the characteristic “active state” can be understood to mean that the electronic control unit controls the control valve, the redundancy valve, and the brake valve. In particular, energization of electromagnets of the control valve, redundancy valve, and brake valve is controlled by the electronic control unit when the electronic control unit is in the active state. In particular, the electronic control unit is in an active state when the ignition of the motor vehicle is switched on and no fault occurs during operation of the electronic control unit that leads to a failure of the electronic control unit.

When the electronic control unit is in the inactive state, the electronic locking unit is set up to control the redundancy valve in such a way that the redundancy valve is set to the open state, whereby pressure fluid from the pressure fluid source is fed into the brake cylinder via the redundancy valve and via the brake valve, which is mechanically preloaded in the open state, and builds up the deactivation pressure in the brake cylinder so that the parking lock is deactivated. On the one hand, this prevents unintentional activation of a parking brake function without the use of two control units while at the same time reacting correctly in the event of a failure of the electronic control unit. Secondly, the brake system enables the driver to activate the parking lock without an additional mechanical interface if the central electronic control unit fails.

In particular, the electronic locking unit is set up to store a normal operation control signal which contains a last valid operating state of the control valve before the state of the electronic control unit has become inactive. In particular, the last valid operating state of the control valve contains the information that the control valve is in the open state. When the control valve is in the open state, pressure fluid is fed from the pressure fluid source via the control valve and the brake valve into the brake cylinder, where it builds up the deactivation pressure so that the parking lock is deactivated. Furthermore, when the electronic control unit is in the inactive state, the electronic locking unit can be set up to control the redundancy valve based on the normal operation control signal in such a way that the redundancy valve is set to the open state. When the redundancy valve is in the open state, pressure fluid is fed from the pressure fluid source via the redundancy valve and the brake valve into the brake cylinder, where it builds up the deactivation pressure so that the parking lock is deactivated.

The driver of the motor vehicle can bring the vehicle to a standstill if the electronic control unit fails by applying the service brake. The driver can then activate the parking lock from the driver's seat by switching off the vehicle's ignition. The function of the electronic locking unit can be dependent on the status of the ignition, wherein the electronic locking unit can check whether or not current is flowing through a corresponding pin (“TRM15”) on an electronic (main) control unit of the vehicle. If the electronic locking unit detects that the ignition of the vehicle is switched off, it can deactivate the redundancy valve so that the redundancy valve goes into a closed state. If the redundancy valve is in the closed state, the pressure escapes from the brake cylinder via the deactivated brake valve back to the now deactivated redundancy valve into a depressurized tank. In this sense, according to a further embodiment, it is provided that the locking unit—when the electronic control unit is in the inactive state and when the ignition of the motor vehicle is switched off—is set up to control the redundancy valve in such a way that the redundancy valve is set to the closed state, so that no pressure fluid from the pressure fluid source is fed via the redundancy valve in the direction of the brake valve. Instead, pressure fluid is drained from the at least one brake cylinder via the brake valve and the redundancy valve into the depressurized tank so that the deactivation pressure within the at least one brake cylinder is reduced and the parking lock is activated.

The redundancy valve is designed in particular as a proportional valve. The speed of activation of the parking brake can be limited by deliberately restricting the flow from the redundancy valve to the tank. In this way, potential misuse by the driver, who performs an ignition cycle while driving while a red warning light is illuminated, for example, can be contained. In this sense, according to a further embodiment, it is provided that the electronic locking unit is set up to control the redundancy valve in such a way that a volume flow of pressure fluid, which is discharged into the depressurized tank via the redundancy valve, is restricted when the redundancy valve is set to the closed state.

To enable the effect of a secondary brake, the brake valve can be controlled in such a way that the pressure is reduced to a level required to achieve the desired secondary braking force. The secondary brake can be released by increasing the pressure again by deactivating the brake valve. The control valve and the redundancy valve are active while the secondary brake is actuated, but do not take part in this function. In this sense, according to a further embodiment, it is provided that the electronic control unit is set up to set the control valve and the redundancy valve to the open state. Furthermore, the electronic control unit is set up to control the brake valve in such a way that sufficient pressure fluid, which has been fed to the brake valve from the pressure fluid source via the control valve and the redundancy valve, reaches the brake cylinder via the brake valve and builds up a secondary brake pressure there, which causes the parking lock to generate a specified secondary braking force. Furthermore, the electronic control unit is designed to set the brake valve to the closed state if the secondary braking force is no longer to be generated.

If the parking lock is to be actuated or activated in normal operation, i.e., if the electronic control unit is in an active state, the control valve and the redundancy valve are deactivated, i.e., set to the closed state, so that the brake cylinder can be vented via the deactivated brake valve. When the brake valve is deactivated, it is in the open state so that pressure fluid flows out of the brake cylinder via the brake valve, the control valve, and the redundancy valve into the depressurized tank. In this sense, according to a further embodiment, the electronic control unit is set up to control the control valve and the redundancy valve in such a way that they move to the closed state. Furthermore, the electronic control unit is set up to set the brake valve to the open state when the electronic control unit is in the active state. This releases pressure fluid from the brake cylinder via the brake valve and via the control valve and the redundancy valve into the depressurized tank, so that the deactivation pressure inside the brake cylinder is reduced and the parking lock is activated.

If the control valve and the redundancy valve have a low flow rate, the speed of emptying the brake cylinder can be increased by activating the brake valve at the same time, i.e., by setting the brake valve to the closed state. The brake valve then vents the brake cylinder directly into the depressurized tank, bypassing the control valve and the redundancy valve. In this situation, the control valve and the redundancy valve merely release the pressure fluid on the way from the control valve or the redundancy valve to the brake valve, which happens very quickly. In this sense, according to a further embodiment, the electronic control unit is designed to set the brake valve to the closed state, whereby pressure fluid is released from the brake cylinder via the brake valve directly into the depressurized tank, so that the deactivation pressure within the at least one brake cylinder is reduced and the parking lock is activated.

### BRIEF DESCRIPTION OF THE DRAWINGS

Exemplary embodiments of the invention are explained in more detail below using the schematic drawing, wherein the same or similar elements are provided with the same reference symbol. The following is shown in the figures below:

FIG. 1 is a top view of a part of a brake system for a motor vehicle and a trailer,

FIG. 2 is an enlarged representation of a part of the brake system according to FIG. 1, and

FIG. 3 shows exemplary state variables of the brake system according to FIG. 1.

### DETAILED DESCRIPTION

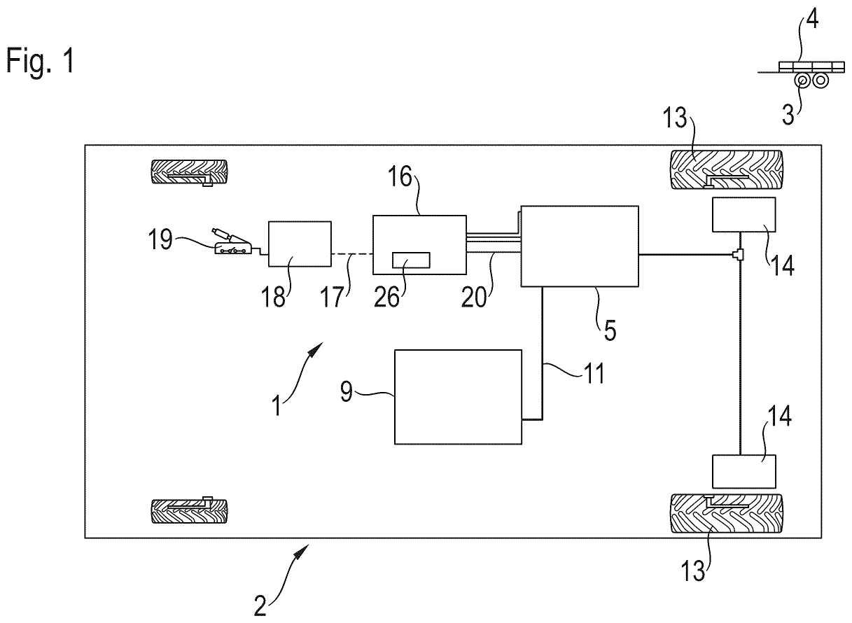

FIG. 1 shows part of a brake system 1 for a motor vehicle 2 (not shown in detail). The motor vehicle 2 is, for example, a commercial agricultural vehicle, in particular a tractor. In particular, the brake system 1 fulfills a parking or endurance braking function (“parking brake function”) of wheels 13 of the motor vehicle 2 and optionally of a trailer brake 3 of a trailed vehicle 4, which is only indicated in FIG. 1. The functions described in more detail below can be part of a tractor brake system platform, the so-called EBP platform. The EBP platform is designed to ensure the safe operation of brake system 1 in various failure scenarios.

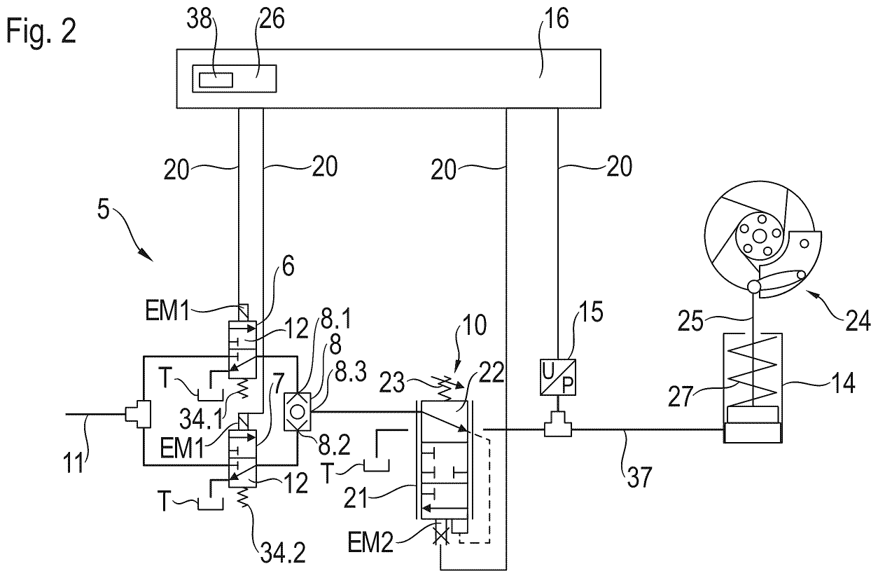

The brake system 1 comprises an electronically controllable parking brake module 5, details of which are shown in FIG. 2. The parking brake module 5 comprises a first 3/2-way directional control valve designed as a control valve 6, a second 3/2-way directional control valve designed as a redundancy valve 7, a pressure-controlled shuttle valve 8 and a 3/3 proportional directional control valve designed as a brake valve 10. The parking brake module 5 is supplied with pressure fluid on the inlet side via a supply line 11 from a pressure fluid source 9, in the exemplary embodiment shown with hydraulic pressure fluid. The control valve 6 and the redundancy valve 7 are each connected to the pressure fluid source 9 on the inlet side via the supply line 11 in a hydraulic parallel circuit. The feature “connected” is to be understood in particular as meaning that the connected elements are hydraulically or pneumatically connected to each other, i.e., that a pressure fluid, e.g., air or a hydraulic fluid, in particular oil, can flow from one element to the other element and vice versa if necessary.

In the depicted exemplary embodiment, the control valve 6 and the redundancy valve 7 are identical parts, which is however not mandatory. A valve slide 12 of the control valve 6 and the redundancy valve 7 are each preloaded in a valve housing, not shown, by a spring element 34.1, 34.2 in a closed switching position (“normally closed”) shown in FIG. 2, which corresponds to a closed state of the control valve 6 and the redundancy valve 7. When the control valve 6 and the redundancy valve 7 are in the closed state, no pressure fluid is fed from the pressure fluid source 9 via the control valve 6 and the redundancy valve 7 in the direction of the shuttle valve 8, the brake valve 10 arranged further downstream and a brake cylinder 14. The valve slides 12 of the control valve 6 and the redundancy valve 7 can be moved from the closed switching position to an open switching position, which corresponds to an open state of the control valve 6 and the redundancy valve 7, by energizing a first electromagnet EM1. The first electromagnet EM1 is energized by an electronic control unit 16. When the control valve 6 and the redundancy valve 7 are in the open state, pressure fluid is fed from the pressure fluid source 9 via the control valve 6 and the redundancy valve 7 and can be fed into the brake cylinder 14 via the shuttle valve 8 and the brake valve 10 located further downstream.

On the output side, the control valve 6 and the redundancy valve 7 are each connected to an inlet 8.1, 8.2 of the shuttle valve 8, so that the respectively higher pressure of the two valves 6, 7 is output via an output 8.3 of the shuttle valve 8 in order to supply two spring-loaded brake cylinders 14, each assigned to a wheel 13, with pressure fluid via the brake valve 10. Optionally, the trailer brake 3 can also be supplied with pressure. If the control valve 6 fails, the pressure of the redundancy valve 7 can continue to be used if the redundancy valve 7 has not failed. If the redundancy valve 7 fails, the pressure of the control valve 6 can continue to be used if the control valve 6 has not failed. A pressure sensor 15 measures the pressure output via the brake valve 10 and transmits the measured pressure to the electronic control unit 16 of the brake system 1.

The brake valve 10 has a valve housing 21, a valve spool 22, a spring element 23, and a second electromagnet EM2. The valve slide 22 of the brake valve 10 is preloaded within the valve housing 21 by the spring element 23 in an open switching position (“normally open”) shown in FIG. 2, which corresponds to an open state of the brake valve 10. When the brake valve 10 is in the open state, pressure fluid that has been fed from the pressure fluid source 9 via the open control valve 6 and the open redundancy valve 7 as well as the shuttle valve 8 is fed into the brake cylinder 14 via the brake valve 10. The pressure fluid builds up a deactivation pressure inside the brake cylinder 14, so that a parking lock 24 is deactivated. FIG. 2 shows only one of the two brake cylinders 14 shown in FIG. 1. However, the explanations in connection with the figure description apply mutatis mutandis to both brake cylinders 14, which are connected to the brake valve 10 in a hydraulic parallel circuit.

A piston rod 25 of the brake cylinder 14 is mechanically connected to the parking lock 24. The piston rod 25 of the brake cylinder 14 is mechanically preloaded by a spring element 26 in such a way that the parking lock 24 is activated, locking the wheels 13. The deactivation pressure counteracts the preload from the spring element 26 and moves the piston rod 25 in such a way that the parking lock 24 is deactivated, as a result of which the wheels 13 are no longer locked. The electronic control unit 16 can control the energization of the second electromagnet EM2 of the brake valve 10 in such a way that the valve slide 22 of the brake valve 10 is moved from the open switching position via a middle position into an open switching position, which corresponds to a closed state of the brake valve 10. When the brake valve 10 is in the closed state, pressure fluid can flow out of the brake cylinder 14 via the brake valve 10 into a depressurized tank T, so that the deactivation pressure is reduced and the parking lock 24 is activated.

When at least one of the valve spools 12 of the two valves 6, 7 is in its open switching position, a specified pressure can be directed via the control valve 6 and/or the redundancy valve 7 and output via the shuttle valve 8. The spring-loaded brake cylinders 14 and the trailer brake 3 can then be actuated via the open brake valve 10 in such a way that the parking lock 24 is released against the spring preload. The wheels 13 of the motor vehicle 2 and/or the trailer 4 are then not locked. If, on the other hand, both valve slides of the two valves 6, 7 are in their closed switching position, then no pressure is fed via the control valve 6 and the redundancy valve 7 and output via the shuttle valve 8 and the open brake valve 10. The spring-loaded brake cylinders 14 and the trailer brake 3 are then not pressurized as described above, but are deflated instead. The wheels 13 of the motor vehicle 2 and/or the trailer 4 are then locked. In this context, it can be said that the valve arrangement 5 has an inverting control characteristic. The parking lock 24 of the motor vehicle 2 and the trailer brake 3 are actuated when no pressure is output via the brake valve 10 and released when a sufficiently high pressure is output via the brake valve 10, which leads to the deactivation pressure within the brake cylinder 14 or in the trailer brake 3.

FIG. 1 shows that the electronic control unit 16 of the brake system 1 can be connected to an electronic (main) control unit 18 of the motor vehicle 2 via a CAN BUS 17. In the exemplary embodiment shown, the electronic (main) control unit 18 of the motor vehicle 2 is connected in particular to a human-machine interface 19. By means of the human-machine interface 19, a driver or user of the motor vehicle 2 can operate the at least one brake cylinder 14 of the motor vehicle 2 and/or the trailer brake 3 of the trailer vehicle 4.

If the parking lock 24 is to be actuated or activated in normal operation, i.e., if the electronic control unit 16 is in an active state, the control valve 6 and the redundancy valve 7 are deactivated, i.e., set to the closed state, so that the brake cylinder 14 can be vented via the deactivated brake valve 10. When the brake valve 10 is deactivated, it is in the open state so that pressure fluid flows out of the brake cylinder 14 via the brake valve 10, the shuttle valve 8, the control valve 6 and the redundancy valve 7 into the depressurized tank T.

If the control valve 6 and the redundancy valve 7 have a low flow rate, the speed at which the brake cylinder 14 is emptied can be increased by simultaneously activating the brake valve 10, i.e., by setting the brake valve 10 to the closed state. The brake valve 10 then vents the brake cylinder 14 directly into the depressurized tank T, bypassing the control valve 6 and the redundancy valve 7. In this situation, the control valve 6 and the redundancy valve 7 merely release the pressure fluid on the way from the control valve 6 or from the redundancy valve 7 to the brake valve 10, which happens very quickly.

To enable the effect of a secondary brake, the electronic control unit 16 controls the brake valve 10 in such a way that the pressure prevailing in the brake cylinder 14 is reduced to a level required to achieve the desired braking force. The secondary brake can be released by increasing the pressure again by deactivating the brake valve via the electronic control unit 16. The control valve 6 and the redundancy valve 7 are active while the secondary brake is actuated, but do not take part in this function.

It may be the case that the control valve 6 and/or the redundancy valve 7 have a mechanical defect, which leads to a jammed opening position of the relevant valve 6 and/or 7. In this case, the pressure inside the brake cylinder 14 cannot be released via the jammed valve 6 and/or 7 when the parking lock 24 is actuated. As long as the ignition of the motor vehicle 2 is switched on or the electronic control unit 16 for controlling the individual devices is energized, this pressure inside the brake cylinder 14 can be relieved by opening the brake valve 10, overcoming the constant supply from the defective valve 6 and/or 7. The electronic control unit 16 will energize the second electromagnet EM2 of the brake valve 10 in such a way that its valve slide 22 is moved into the closed position. When the valve slide 22 is in the closed position, the brake cylinder 14 is connected to the depressurized tank T via the brake valve 10, whereas the control valve 6 and the redundancy valve 7 are separated from the brake cylinder 14. As a result, pressure fluid flows out of the brake cylinder 14 via the brake valve 10 directly into the depressurized tank T of the brake system 1. Furthermore, no pressure fluid is fed from the pressure fluid source 9 via the control valve 6 or redundancy valve 7, the shuttle valve 8 and the brake valve 10 into the brake cylinder 14.

If the electronic control unit 16 is now also to be switched off, the second electromagnet EM2 of the brake valve 10 would normally no longer be energized. This would put the brake valve 10 into the preloaded state, i.e., the valve slide 22 would be moved by the spring 23 into the open switching position shown in FIG. 2. This would pressurize the brake cylinder 14 again and release the parking brake 24. To avoid such a risky situation, the electronic control unit 16 (before it switches itself off or is allowed to be switched off) alternately sets the brake valve 10 to the open and closed state. This happens when the ignition of the motor vehicle 2 is switched off, so that the engine for driving the motor vehicle 1 is no longer running and the pressure fluid source is no longer being filled. As a result, the brake cylinder 14 is alternately filled, pressurized and vented again, so that the pressure fluid source 9, which feeds the brake cylinder 14, is emptied in such a way that the deactivation pressure is no longer reached within the brake cylinder 14 during its filling.

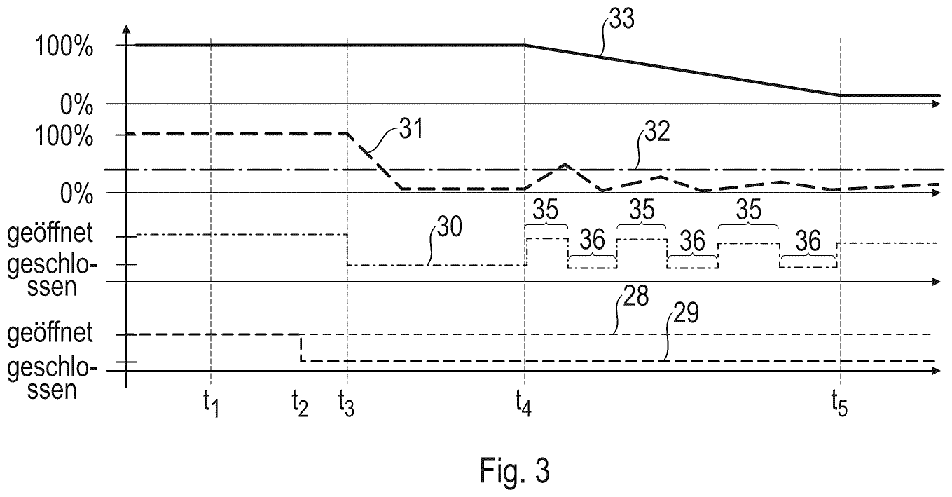

FIG. 3 illustrates the scenario described above in time sequences of status values. For example, a first graph 28 shown in FIG. 3 below shows the progression of the state of the control valve 6 over time. Another second graph 29 shown in FIG. 3 below shows the progression of the state of the redundancy valve 7 over time. Above the first and second graphs 28, 29, a third graph 30 shows the progression of the state of the brake valve 10 over time. Above the third graph 30, a fourth graph 31 shows the variation over time of the relative pressure (0% corresponds to a depressurized state 100% to a maximum permissible pressure) that prevails within the brake cylinder 14. A limit 32 for the pressure is also shown. If the pressure prevailing inside the brake cylinder 14 is below the limit 32, the parking lock 24 is activated. The limit 32 can, for example, be the deactivation pressure described above. Alternatively, a lower value can also be selected to prevent increased security against unintended deactivation of the parking lock 24. Above the fourth graph 31, a fifth graph 32 shows the progression of an output pressure of the pressure fluid source 9 over time.

At a first point in time t₁, the motor vehicle 2 is stopped, e.g., by means of a service brake. The control valve 6, the redundancy valve 7, and the brake valve 10 remain in their open state, so that a pressure above the limit 32 continues to prevail inside the brake cylinder 14, whereby the parking lock 24 remains deactivated. At a subsequent second time t₂, the activation of the parking lock 24 is initiated, e.g., by the driver operating the human-machine interface 19 accordingly. From the second time t₂, the redundancy valve 7 is moved by its spring element 34.2 from the open switching position to the closed switching position. However, this does not work with the control valve 6 because a mechanical defect ensures that the spring element 34.1 of the control valve 6 cannot move its valve spool 12 into the closed position. The control valve 6 thus remains in the open state. The brake valve 10 remains in its open state as intended. The pressure 31 inside the brake cylinder 14 does not drop, as the control valve 6 is still open, so that pressure fluid from the pressure fluid source 9 continues to flow unintentionally into the brake cylinder 14 via the control valve 6, the shuttle valve 8, and the brake valve 10.

At a subsequent third time t₃, the electronic control unit 16 recognizes that the control valve 6 is in the open state, although it should be in the closed state to activate the parking lock 24. In order to nevertheless enable activation of the parking lock 24, the electronic control unit 16 energizes the second electromagnet EM2 of the brake valve 10 in such a way that its valve slide 22 moves into the closed switching position. As a result, pressure fluid flows out of the brake cylinder 14 via the brake valve 10 directly into the depressurized tank T. This causes the pressure 31 inside the pressure cylinder 14 to fall below the limit 32 and the parking lock 24 is activated.

At a subsequent fourth time t₄, the ignition of the motor vehicle 2 is switched off so that the pressure fluid source 9 is no longer filled and can be emptied. The electronic control unit 16 now energizes the second electromagnet EM2 of the brake valve 10 in such a way that its valve slide 22 moves alternately into the open and closed switching position. As a result, during an opening cycle 35 (in which the brake valve 10 is open), pressure fluid from the emptying pressure fluid source 9 enters the brake cylinder 14 via the control valve 6, the shuttle valve 8, and the brake valve 10, which remain open, so that pressure builds up in the brake cylinder 14. This pressure is released again in a closing cycle 36 (in which the brake valve is closed) following the opening cycle 35. FIG. 3 shows that the limit 32 is still exceeded during the first opening cycle 35 of the brake valve 10, but is no longer exceeded during the subsequent opening cycles 35.

As soon as the electronic control unit 16 recognizes that the limit 32 is no longer reached during an opening cycle of the brake valve 10, it can switch off at a fifth time t₅. In the exemplary embodiment shown in FIG. 3, the electronic control unit 16 waits for a further opening cycle before initiating its shutdown. When the electronic control unit 16 is switched off, it is in an inactive state so that the brake valve 10 is set to its mechanically preloaded open state. The redundancy valve 7 remains in its mechanically preloaded closed state. The control valve 6 remains in its jammed open state. However, insufficient pressure fluid is fed from the at least partially emptied pressure fluid source 9 via the control valve 6, the shuttle valve 8 and the brake valve 10 into the brake cylinder 14 in order to build up the deactivation pressure in the brake cylinder 14 and deactivate the parking lock 24. In order to detect the pressure inside the brake cylinder 14, the brake system 1 has a pressure sensor 15 in the exemplary embodiment shown. The pressure sensor 15 measures a line pressure within a brake cylinder line 37, which connects the brake valve 10 with the brake cylinder 14. The processor unit 16 accesses the line pressure measured by the pressure sensor 15 and can switch off as described above if the line pressure no longer reaches the predetermined limit during the filling of the brake cylinder 14 (i.e., during one of the opening cycles 35 described above).

It is also intended to prevent the pressure supply to the brake cylinder 14 and the trailer brake 3 from failing while the motor vehicle 2 and the trailer vehicle 4 are in motion and the wheels 13 of the motor vehicle 2 or the trailer vehicle 4 from becoming immobilized. This pressure supply function is controlled by the electronic control unit 16 of the brake system 1 during normal operation of the brake system 1. For this purpose, the electronic control unit 16 of the brake system 1 is connected to the control valve 6 and the redundancy valve 7 via one electronic control line 20 each. When the electronic control unit 16 of the brake system 1 energizes the first electromagnets EM1 of the control valve 6 and the redundancy valve 7 via the electronic control lines 20, the valve slides 12 of the control valve 6 and the redundancy valve 7 are moved against the spring preload from the closed switching position to the open switching position.

However, if the electronic control unit 16 of the brake system 1 does not function properly in a fault mode (inactive state of the electronic control unit 16), then this function is controlled by an electronic locking unit 26 described in more detail below, which is integrated into the electronic control unit 16 in the exemplary embodiment according to FIG. 1. The control valve 6 moves into the closed state due to the mechanical preload when the electronic control unit 16 is in the inactive state. As a result, no pressure fluid is fed from the pressure fluid source 16 via the control valve in the direction of the brake valve 24. Accordingly, no pressure fluid is fed into the brake cylinder 14 via the control valve 6 and the brake valve 7 in order to build up the deactivation pressure so that the parking lock 24 is deactivated. To counteract this, when the electronic control unit 16 is in the inactive state, the electronic locking unit 26 controls the redundancy valve 7 in such a way that the redundancy valve 7 is set to the open state. As a result, pressure fluid from the pressure fluid source 9 is fed into the brake cylinder 14 via the redundancy valve 7 and the brake valve 10, which is mechanically preloaded in the open state, and builds up the deactivation pressure in the brake cylinder 14 so that the parking lock 24 is deactivated.

To implement this functionality, the electronic locking unit 26 stores a normal operation control signal 38. This normal operation control signal 38 contains or describes a last valid operating state of the control valve 6 before the electronic control unit 16 became inactive. The last valid operating state of the control valve 6 contains, in particular, the information that the control valve 6 is in the open state. When the electronic control unit 16 is in the inactive state, the electronic locking unit 26 controls the first solenoid EM1 of the redundancy valve 7 based on the normal operation control signal 38 such that the valve spool 12 of the redundancy valve 7 is moved to the open position. When the redundancy valve 7 is thus in the open state, pressure fluid is fed from the pressure fluid source 9 via the redundancy valve 7, the shuttle valve 8 and the brake valve 10, which is mechanically preloaded in the open state, into the brake cylinder 14, where it builds up the deactivation pressure so that the parking lock 24 is deactivated.

If the electronic control unit 16 has failed, the driver can bring the motor vehicle 2 to a standstill by applying the service brake. The driver can then activate the parking lock 24 from the driver's seat by switching off the ignition of the motor vehicle 2. The function of the electronic locking unit 26 can be dependent on the status of the ignition, wherein the electronic locking unit 26 can check whether current is flowing through a corresponding pin (“TRM15”) on the electronic control unit 18 of the motor vehicle 2 or not. If the electronic locking unit 26 detects that the ignition of the motor vehicle 2 is switched off, it can deactivate the redundancy valve 7 so that the redundancy valve 7 moves to the closed state. When the redundancy valve 7 is in the closed state, the pressure escapes from the brake cylinder 14 via the brake valve 10, which is preloaded in the open state, back to the now deactivated redundancy valve 7 into the depressurized tank T. The speed of activation of the parking lock 24 can be limited by deliberately restricting the flow from the redundancy valve 7, which is designed as a proportional valve, to the depressurized tank T. This can be done by the electronic locking unit 26 energizing the electromagnet EM1 of the redundancy valve 7 accordingly. In this way, potential misuse by the driver performing an ignition cycle while a red warning light is illuminated can be contained.

### LIST OF REFERENCE NUMERALS

A1 Pressure agent source connection
A2 Tank connection
A3 Brake Cylinder Connector
EM1 Electromagnetic control valve/redundancy valve
EM2 Electromagnet brake valve
t₁ First time point
t₂ Second time
t₃ Third time point
t₄ Fourth time
t₅ Fifth time
T Depressurized tank
1 Brake system
2 Motor vehicle
3 Trailer brake
4 Hinged vehicle
5 Parking brake module
6 Control valve
7 Redundance valve
8 Shuttle valve
8.1 First inlet of shuttle valve
8.2 Second inlet shuttle valve
8.3 Outlet shuttle valve
9 Pressure fluid source
10 Brake valve
11 Supply line
12 Valve slider
13 Rad
14 Brake cylinder
15 Pressure sensor
16 Electronic control unit of the brake system
17 CAN bus
18 Electronic control unit of the motor vehicle
19 Human-Machine Interface
20 Electronic control cable
21 Valve housing
22 Valve slider
23 Spring element
24 Parking lock
25 Piston rod
26 Electronic locking unit
27 Spring element
28 Temporal progression of the status of the control valve
29 Time progression of the redundancy valve status
30 Temporal progression of the state of the brake valve
31 Temporal progression of brake cylinder pressure
32 Limit pressure
33 Time progression of the pressure source output
34.1 Spring element control valve
34.2 Spring element redundancy valve
35 Opening cycle
36 Closure cycle
37 Brake cylinder line
38 Normal operation control signal

1. A brake system (1) for a motor vehicle (2), the brake system (1) comprising:
a first directional control valve adapted as a directional control valve (6);
a second directional control valve designed as a redundancy valve (7);
a third directional control valve adapted as a brake valve (10);
a brake cylinder (14);
a pressure means source (9);
an electronic control unit (16);
a parking lock (24); and
a depressurized tank (T), wherein:
the control valve (6) and the redundancy valve (7) are mechanically preloaded in a closed state,
the brake valve (10) is mechanically preloaded in an open state, and
the electronic control unit (16) configured
(i) to control the control valve (6) and the redundancy valve (7) in such a way that they move into an open state against the mechanical pretension, whereby pressure fluid can be fed from the pressure fluid source (9) via the control valve (6) and the redundancy valve (7) and downstream via the brake valve (10), which is mechanically preloaded in the open state, into the brake cylinder (14) and whereby pressure can build up a deactivation pressure in the brake cylinder (14), so that the parking lock (24) is deactivated, and
(ii) to control the brake valve (10) in such a way that it moves into a closed state so that pressure fluid can flow out of the brake cylinder (14) via the brake valve (10) directly into the depressurized tank (T) and no pressure fluid is fed into the brake cylinder (14) via the control valve (6) or the redundancy valve (7) and the brake valve (10), if the control valve (6) or the redundancy valve (7) remains in the open state due to a mechanical defect and otherwise should be in the closed state.

2. The brake system (1) according to claim 1, wherein, when an ignition of the motor vehicle (2) is switched off, the electronic control unit (16) is configured to control the brake valve (10) such that it alternately moves into the open state and into the closed state, and so that the brake cylinder (14) is alternately filled and emptied until the pressure fluid source (9) is emptied such that the pressure within the brake cylinder (14) no longer reaches a fixed limit pressure (32) during its filling.

3. The brake system (1) according to claim 2, wherein the electronic control unit (16) is arranged to switch off when the pressure within the brake cylinder (14) no longer reaches the limit pressure (32) during its filling.

4. The brake system (1) according to claim 2, further comprising a pressure sensor (15), wherein
the pressure sensor (15) is arranged to measure a line pressure within a line (37) connecting the brake valve (10) to the brake cylinder (14), and
the processor unit (16) is configured to access the line pressure measured by the pressure sensor (15) and to switch off if the line pressure no longer reaches the predetermined limit (32) during the filling (35) of the brake cylinder (14).

5. The brake system (1) according to claim 1, further comprising an electronic locking unit (26), wherein
the control valve (6) moves into the closed state due to the mechanical preload when the electronic control unit (16) is in an inactive state, so that no pressure fluid is fed from the pressure fluid source (9) via the control valve (6) in the direction of the brake valve (10), and
the electronic locking unit (26), when the electronic control unit (16) is in the inactive state, is configured to control the redundancy valve (7) in such a way that the redundancy valve (7) is set to the open state, whereby pressure fluid from the pressure fluid source (9) is fed into the brake cylinder (14) via the redundancy valve (7) and the brake valve (10), which is mechanically preloaded in the open state, and builds up the deactivation pressure in the brake cylinder (14) so that the parking lock (24) is deactivated.

6. The brake system (1) according to claim 5, wherein the electronic locking unit (26) configured
(i) to store a normal operation control signal (38) containing a last valid operating state of the control valve (6) before the state of the electronic control unit (16) has become inactive, and
(ii) to control the redundancy valve (7), when the electronic control unit (16) is in the inactive state, based on the normal operation control signal (38) in such a way that the redundancy valve (7) is set to the open state.

7. The brake system (1) according to claim 1, wherein the interlocking unit (26) is configured to control the redundancy valve (7) in such a way that the redundancy valve (7) is set to the closed state when the electronic control unit (16) is in the inactive state and when the ignition of the motor vehicle (2) is switched off, so that no pressure fluid is fed from the pressure fluid source (9) via the redundancy valve (7) in the direction of the brake valve (14), but instead pressure fluid is released from the at least one brake cylinder (14) via the brake valve (10) and the redundancy valve (7) into the depressurized tank (T), so that the deactivation pressure within the at least one brake cylinder (14) is reduced and the parking lock (24) is activated.

8. The brake system (1) according to claim 7, wherein the electronic interlock unit (26) is arranged to control the redundancy valve (7) in such a way that a volume flow of pressure fluid discharged into the depressurized tank (T) via the redundancy valve (7) is restricted when the redundancy valve (7) is set to the closed state.

9. The brake system (1) according to claim 1, wherein the electronic control unit (16) is configured
(i) to set the control valve (6) and the redundancy valve (7) to the open state,
(ii) to control the brake valve (10) in such a way that sufficient pressure fluid, which has been fed from the pressure fluid source (9) via the control valve (6) and the redundancy valve (7) to the brake valve (10), reaches the brake cylinder (14) via the brake valve (10) and builds up a secondary brake pressure there, which results in the parking lock (24) generating a provided secondary brake force, and
(iii) to set the brake valve (10) to the closed state if the secondary braking force is no longer to be generated.

10. The brake system (1) according to claim 1, wherein the electronic control unit (16) is configured
(i) to control the control valve (6) and the redundancy valve (7) in such a way that they move to the closed state, and
(ii) to set the brake valve (10) to the open state when the electronic control unit (16) is in the active state, whereby pressure fluid is released from the brake cylinder (14) via the brake valve (10) and via the control valve (6) and the redundancy valve (7) into the depressurized tank (T), so that the deactivation pressure within the brake cylinder (14) is reduced and the parking lock (24) is activated.
